(19) United States
(12) Patent Application Publication
(10) Pub. No.: US 2004/0247172 A1
(43) Pub. Date: Dec. 9, 2004

(54) Pattern measuring apparatus, pattern measuring method, and manufacturing method of semiconductor device

(76) Inventor: Tadashi Mitsui, Kanagawa (JP)

Correspondence Address: Finnegan, Henderson, Farabow,, Garrett & Dunner, L.L.P., 1300 I Street, N.W., Washington, DC, 20005-3315, US

(21) Appl. No.: 10/807,187

(22) Filed: Mar. 24, 2004

(30) Foreign Application Priority Data
Mar. 25, 2003 (JP) 2003-83324

(51) Int. Cl. G06K 9/00

(52) U.S. Cl. 382/141

(57) ABSTRACT

A pattern measuring apparatus includes: a storage device which stores a plurality of pattern images of a pattern to be measured and edge reference data which is used as reference to detect the edge of the pattern within the pattern images and is configured of a plurality of pixels that are disposed so as to have an intensity gradient, the pattern images being obtained by an external imaging device at different focal distances; a calculator which scans the pattern image with the edge reference data, detects edge points of the pattern, and also calculates a characteristic quantity that expresses a correlation between the edge reference data and the detected edge points of the pattern; a determinator which determines an in-focus state that expresses the degree to which the focal position at which each pattern image is obtained conforms to a desired pattern edge, based on the calculated characteristic quantity; an image selector which selects the pattern image that conforms to measurement of the pattern from a plurality of the pattern images, in accordance with the determination result of the in-focus state determinator; and a measurer which processes the selected pattern image to measure the pattern.

### CROSS REFERENCE TO RELATED APPLICATION

This application claims benefit of priority under 35USC §119 to Japanese Patent Application No. 2003-83324, filed on Mar. 25, 2003, the contents of which are incorporated by reference herein.

### BACKGROUND OF THE INVENTION

1. Field of the Invention

The present invention relates to a pattern measuring apparatus, a pattern measuring method, and a method of manufacturing a semiconductor device, which are involved in pattern measurement using image processing, by way of example.

2. Related Background Art

The description below relates to the evaluation of micro-patterns formed by a method such as lithography or etching, as an example of the measurement of patterns by techniques relating to the present invention.

A widely used method of evaluating semiconductor micro-patterns is to measure the dimensions thereof by using a critical dimension scanning electron microscope (CDSEM). With CDSEM, a pattern to be measured is viewed from above, a SEM image is captured thereof, and the critical dimensions of parts of the pattern are measured from that SEM image. To obtain a clear pattern image, the SEM image is captured after it has been brought into focus by an automatic focusing method called auto-focus. This automatic focusing method has been disclosed in Japanese Patent Laid-Open No. 5-190132, by way of example.

Even when the method disclosed in Japanese Patent Laid-Open No. 5-190132 is used, however, it could happen that an image is misjudged as being that of a pattern image that is in focus, even though it is not actually in focus, so that erroneous check results are output and thus the precision of the focusing is not always considered satisfactory. In addition, the line profile could become indistinct if the edge of the pattern is not orthogonal to the scanning direction of the electron beam, and focusing by a prior-art method could make it difficult to detect the correct focal position, for reasons such as a momentary change due to charging or contamination of a sample. It is also considered impossible to reproduce the pattern images because of factors such as the stability of the power source, when setting parameters of the electron beam optical system to the detected values (usually the excitation current of the objective lens) by the focusing process again.

Furthermore, a semiconductor micro-pattern usually has a three-dimensional structure of a height from a few nm to a few μm. For that reason, when such a pattern is observed in a SEM image, it could happen that portions thereof that are focused (in-focus) and portions thereof that are not focused (out-of-focus) are mixed together within the same image. This is clearly not preferable, not only from the objective of observing the images, but also from the objective of measuring pattern dimensions from those images. The design of CDSEM tends to give the electron beam electrical system a deep focal depth, to solve such problems.

However, increasing the focal depth generally reduces the resolution. To inspect semiconductor micro-patterns, by way of example, the focal depth of the electron beam optical system must be set to no more than approximately 1 μm, since the optical system must maintain a resolution of approximately 1 nm. If automatic focusing is used to focus on the part of the pattern to be measured and if that precision is estimated to be approximately half the focal depth, it is inevitable that there will be a mixture of focused edge lines and unfocused edge lines within the same image, even if the height differences of the pattern edges are within 1 μm.

To solve the above-described problems, methods have been proposed of combining pattern images while calculating a characteristic quantity that indicates in-focus state, while a sequence of pattern images with varying focal depths is being read in, and then performing the inspection on the thus-combined pattern images, as disclosed in Japanese Patent Laid-Open No. 2001-84944, by way of example.

The method disclosed in Japanese Patent Laid-Open No. 2001-84944, however, has problems in that it places an extremely large load on the central processing unit (CPU) of the computer when it comes to calculating the characteristic quantity and combining the pattern images, which necessitates a corresponding increase in the processing time and increases the cost of pattern measurement.

### BRIEF SUMMARY OF THE INVENTION

According to a first aspect of the present invention, there is provided a pattern measuring apparatus comprising:

a storage device which stores a plurality of pattern images of a pattern to be measured and edge reference data which is used as reference to detect the edge of the pattern within the pattern images and is configured of a plurality of pixels that are disposed so as to have an intensity gradient, the pattern images being obtained by an external imaging device at different focal distances;

a calculator which scans the pattern image with the edge reference data, detects edge points of the pattern, and also calculates a characteristic quantity that expresses a correlation between the edge reference data and the detected edge points of the pattern;

a determinator which determines an in-focus state that expresses the degree to which the focal position at which each pattern image is obtained conforms to a desired pattern edge, based on the calculated characteristic quantity;

an image selector which selects the pattern image that conforms to measurement of the pattern from a plurality of the pattern images, in accordance with the determination result of the in-focus state determinator; and

a measurer which processes the selected pattern image to measure the pattern.

According to a second aspect of the present invention, there is provided a pattern measuring apparatus which is connectable to an external imaging device and which inspects a pattern to be measured on the basis of a pattern image supplied from the external imaging device, the external imaging device capturing an image of the pattern to be measured with an optical system, a focal position of the optical system being adjustable with respect to the pattern by an integer multiple of a predetermined step width from a predetermined initial value, the pattern measuring apparatus comprising:

a storage device which stores edge reference data which is used as reference to detect the edge of the pattern within pattern images and which is configured of a plurality of pixels that are disposed so as to have an intensity gradient;

a characteristic quantity calculator which scans each pattern image with the edge reference data, detects edge points of the pattern to be measured, and also calculates a characteristic quantity that expresses a correlation between the detected pattern and the edge reference data;

a determinator which determines an in-focus state that expresses the degree to which the focal position at which each pattern image is obtained conforms to a desired pattern edge, based on the characteristic quantity that has been calculated;

a measurer which operates to process the pattern image to measure the pattern if the determinator has determined that the focal position at the time of capture of the pattern image conforms to the desired pattern edge,; and

a focal-position controller which generates and outputs control signals to change the focal position of the optical system of the external imaging device if the determinator has determined that the focal position at the time of capture of the pattern image does not conform to the desired pattern edge.

According to a third aspect of the present invention, there is provided a method of measuring a pattern to be measured from a plurality of pattern images obtained by capturing the pattern by an imaging device at different focal positions, the pattern measuring method comprising:

detecting edge points of a pattern to be measured by scanning the pattern with edge reference data which is used as reference to detect the edges of the pattern within pattern images and which is configured of a plurality of pixels that are disposed so as to have an intensity gradient, and also calculating a characteristic quantity which expresses a correlation between the edge reference data and the pattern, the edge points of which have been detected;

determining an in-focus state that expresses the degree to which the focal position at which each obtained pattern image is obtained conforms to a desired pattern edge, based on the characteristic quantity that has been calculated;

selecting the pattern image which conforms to measurement of the pattern from a plurality of the pattern images, in accordance with the result of determining the in-focus state; and

processing the selected pattern image to measure the pattern.

According to a fourth aspect of the present invention, there is provided a method of measuring a pattern based on an image of a pattern to be measured which is obtained by an imaging device which captures the pattern to be measured and includes an optical system with a focal position thereof being adjustable with respect to the pattern by an integer multiples of a predetermined step width from an initial value, the method comprising:

detecting edge points of a pattern to be measured by scanning an image of the pattern with edge reference data which is used as reference to detect the edge points of the pattern and which is configured of a plurality of pixels that are disposed so as to have an intensity gradient, and calculating a characteristic quantity which expresses a correlation between the edge reference data and the pattern, the edge of which has been detected;

determining an in-focus state that expresses the degree to which the focal position at which each pattern image is obtained conforms to a desired pattern edge, based on the characteristic quantity that has been calculated;

processing the image of the pattern to measure the pattern if it has been determined that the focal position at the time of capture of the pattern image conforms to the desired pattern edge; and

obtaining a new image of the pattern at different focal positions until it is determined that it conforms to the desired pattern edge by varying the focal position of the optical system if it has been determined that the focal position at the time of capture of the pattern image does not conform to the desired pattern edge.

According to a fifth aspect of the present invention, there is provided a method of manufacturing a semiconductor device comprising a method of measuring a pattern to be measured from a plurality of pattern images captured and obtained at different focal positions by a pattern imaging device, the method of measuring the pattern including:

detecting edge points of a pattern to be measured by scanning the pattern with edge reference data which is used as reference to detect the edges of the pattern within pattern images and which is configured of a plurality of pixels that are disposed so as to have an intensity gradient, and also calculating a characteristic quantity which expresses a correlation between the edge reference data and the pattern, the edge points of which have been. detected;

determining an in-focus state that expresses the degree to which the focal position at which each obtained pattern image is obtained conforms to a desired pattern edge, based on the characteristic quantity that has been calculated;

selecting the pattern image which conforms to measurement of the pattern from a plurality of the pattern images, in accordance with the result of determining the in-focus state; and

processing the selected pattern image to measure the pattern.

According to a sixth aspect of the present invention, there is provided a method of manufacturing a semiconductor device comprising a method of measuring a pattern based on an image of a pattern to be measured which is obtained by an imaging device which captures the pattern to be measured and includes an optical system with a focal position thereof being adjustable with respect to the pattern by an integer multiples of a predetermined step width from an initial value, the method of measuring the pattern including:

detecting edge points of a pattern to be measured by scanning an image of the pattern with edge reference data which is used as reference to detect the edge points of the pattern and which is configured of a plurality of pixels that are disposed so as to have an intensity gradient, and calculating a characteristic quantity which expresses a correlation between the edge reference data and the pattern, the edge of which has been detected;

determining an in-focus state that expresses the degree to which the focal position at which each pattern image is obtained conforms to a desired pattern edge, based on the characteristic quantity that has been calculated;

processing the image of the pattern to measure the pattern if it has been determined that the focal position at the time of capture of the pattern image conforms to the desired pattern edge; and

obtaining a new image of the pattern at different focal positions until it is determined that it conforms to the desired pattern edge by varying the focal position of the optical system if it has been determined that the focal position at the time of capture of the pattern image does not conform to the desired pattern edge.

### BRIEF DESCRIPTION OF THE DRAWINGS

In the drawings:

FIG. 1 is a block diagram of the basic configuration of an embodiment in which the present invention is applied to a pattern measuring apparatus;

FIG. 2 shows a specific example of a line pattern that is an object to be inspected;

FIG. 3 is a block diagram that is illustrative of a first embodiment of a pattern measuring method in accordance with the present invention;

FIGS. 4A to 4E are schematic views of specific examples of a plurality of pattern images obtained at different focal distances;

FIG. 5 shows a specific example of edge reference data having a linear intensity gradient;

FIG. 6 shows a specific example of edge reference data having a nonlinear intensity gradient;

FIG. 7 is a graph of standardized correlation values obtained from the pattern images of FIGS. 4A to 4E;

FIG. 8A shows a pattern image of a specific example of a hole pattern and FIG. 8B shows a section through the hole pattern of FIG. 8A;

FIGS. 9A to 9E are schematic views of specific examples of pattern images obtained by imaging the hole pattern of FIGS. 8A and 8B at different focal distances;

FIG. 10 is a graph of the relationship between standardized correlation value Rn and focal distance for the pattern images of FIGS. 9A to 9E;

FIG. 11 is a graph of the relationship between the standardized correlation value Rn and focal distance for the pattern images of FIGS. 9A to 9E without the implementation of grouping;

FIG. 12 shows a composite image of the related pattern images of FIGS. 9A to 9E;

FIG. 13 shows an example of a pattern configured of a plurality of patterns having different edges;

FIG. 14 shows an example of a pattern obtained by imaging the pattern of FIG. 13;

FIG. 15 shows a typical graph of the relationship between the standardized correlation value Rn and focal distance for the pattern image of FIG. 14, obtained when a single set of edge reference data is used;

FIGS. 16A and 16B are specific examples of a plurality of sets of edge reference data that have been defined beforehand for the plurality of patterns of FIG. 13 so as to conform to the edges of the patterns; and

FIG. 17 is a graph of the relationship between the standardized correlation value Rn and focal distance, obtained by scanning the pattern image of FIG. 14 with the edge reference data shown in FIGS. 16A and 16B.

### DETAILED DESCRIPTION OF THE INVENTION

Embodiments of the present invention are described below with reference to the accompanying figures. The description below takes the example of the processing of a SEM image obtained by CDSEM used in pattern measurement of the semiconductor fabrication process. The present invention is not, however, limited thereto and thus it can provide a pattern measurement method that is suitable in a wide variety of fields in which image processing is used, as well as to apparatuses that implement such methods. It is also not limited to SEM images and thus can be applied in a similar manner to optical images obtained by optical imaging devices, by way of example.

(1) Embodiment of Pattern Measuring Apparatus

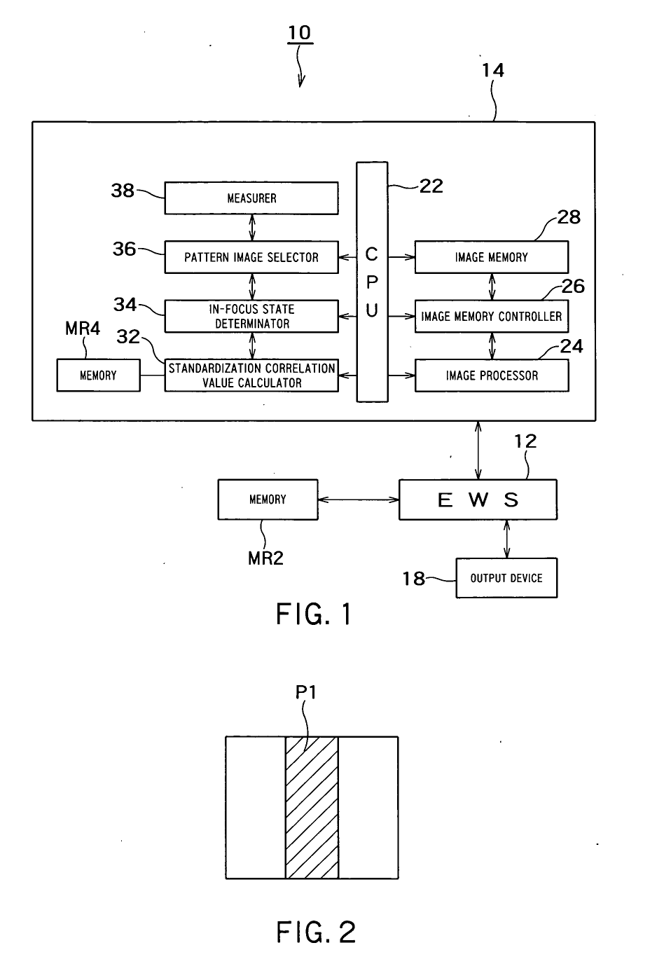

A schematic block diagram of the configuration of an embodiment of a pattern measuring apparatus in accordance with the present invention is shown in FIG. 1. A pattern measuring apparatus 10 shown in this figure comprises a workstation (EWS) 12, an image processor 14, a memory MR2, and an output device 18.

The memory MR2 contains a recipe file in which is written a specific procedure for implementing the pattern measuring method of the present invention, as algorithms that will be described later. The output device 18 displays pattern images or the like that have been processed by the processor 14, as will be described later, on a display or the like. The workstation 12 reads the recipe file from the memory MR2 and controls the entire apparatus in accordance with that recipe file. The workstation 12 also generates and outputs control signals for varying the focus position of an optical system with respect to an external pattern image capturing device, in accordance with the results of a determination done by an in-focus state determinator of the processor 14. This point will be described later.

The processor 14 includes a CPU 22, an image processor 24, an image memory controller 26, an image memory 28, a standardized correlation value calculator 32, an in-focus state determinator 34, a pattern image selector 36, a measurer 38, and a memory MR4.

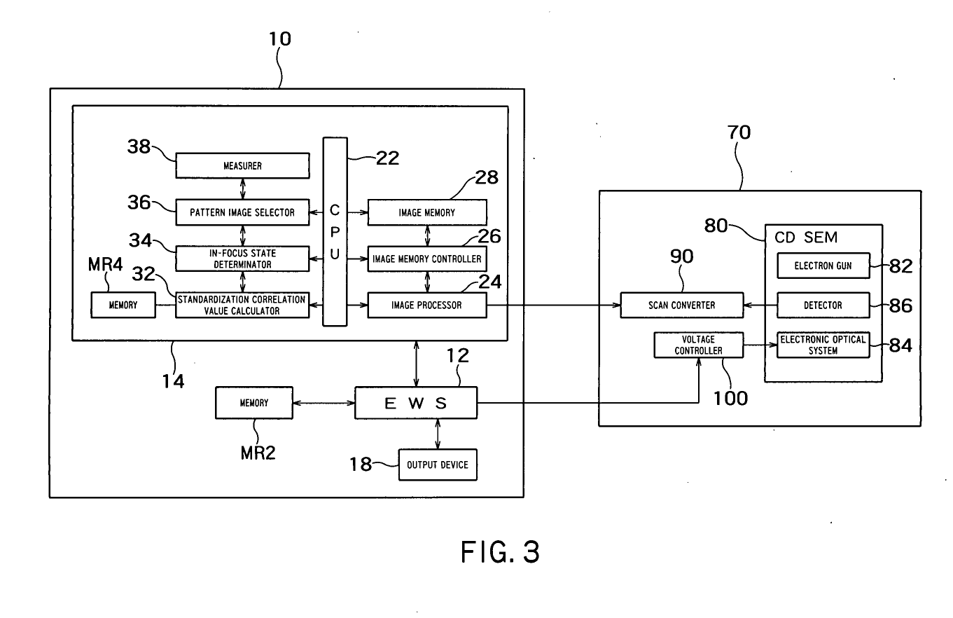

Within the memory MR4 is stored previously-defined edge reference data that acts as reference for determining pattern edges within a pattern image that has been obtained by capturing a pattern to be measured. The image processor 24 receives a series of pattern image (such as SEM image) data obtained by capturing the pattern to be measured at different focal distances from an external imaging device such as an electron beam apparatus (see FIG. 3), and outputs positional coordinates of edge points) of the pattern and correlation values at those points, by scanning each pattern image with the edge reference data. The image memory controller 26 stores coordinate position data for the pattern edge points in the image memory 28, and also allocates an address to each pattern image. The standardized correlation value calculator 32 receives coordinate value data for the edge points from the image processor 24 and calculates the standardized correlation value Rn for each pattern image. The in-focus state determinator 34 receives the thus-calculated standardized correlation values Rn and determines the in-focus state with respect to the pattern to be measured, from the pattern images. The pattern image selector 36 receives the determination result of the in-focus state determinator 34 and selects the pattern image in which the focal position conforms best to the edge of the targeted pattern, or which has the closest match to that state, from the string of pattern images. The measurer 38 measures details such as the dimensions and state of the pattern, based on the pattern image selected by the pattern image selector 36.

The description now turns to the operation of the pattern measuring apparatus 10 of FIG. 1, as embodiments of the pattern measuring method in accordance with the present invention.

(2) First Embodiment of Pattern Measuring Method

This embodiment is described with reference to the measurement by CDSEM of the line pattern shown in FIG. 2, by way of example.

A block diagram used for illustrating the pattern measuring method of this embodiment is shown in FIG. 3. As shown in this figure, the previously described pattern measuring apparatus 10 is connected to an electron beam apparatus 70. The electron beam apparatus 70 includes a CDSEM 80, a scan converter 90, and a voltage controller 100. The CDSEM 80 comprises an electron gun 82, and electronic optical system 84, and a detector 86. The electron gun 82 generates an electron beam that it emits towards a sample (not shown in the figure) on which a pattern to be measured has been formed. The electronic optical system 84 receives control signals from the voltage controller 100 and scans the surface of the sample with the electron beam, while controlling the path of the electron beam in such a manner as to focus the electron beam onto the surface of the pattern to be measured. The voltage controller 100 is connected to the workstation 12 of the pattern measuring apparatus 10 and it receives control signals for controlling the electronic optical system 84. These control signals includes signals for controlling an excitation current to an objective lens (not shown in the figure) in the electronic optical system 84. The detector 86 detects secondary electrons or the like that are reflected out from the surface of the sample illuminated with the electron beam. The scan converter 90 converts the secondary electron signal that is output from the detector 86 into a video signal, and supplies it to the image processor 24 of the pattern measuring apparatus 10 as a digital signal forming a pattern image.

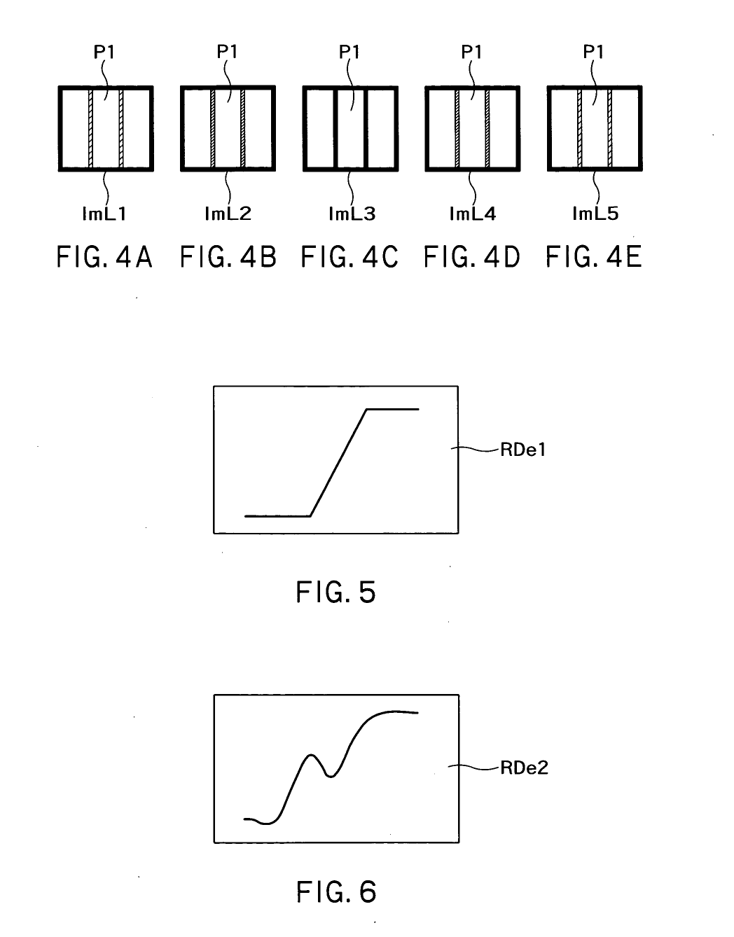

A specific sequence of the pattern measuring method is as follows: first of all, the workstation 12 of the pattern measuring apparatus 10 generates control signals for causing the excitation current to the objective lens (not shown in the figure) within the electronic optical system 84 to vary and transmits those signals to the voltage controller 100 to obtain a plurality of pattern images that are captured of the pattern to be measured at mutually different focal distances. Specific examples of the thus-obtained pattern images are shown schematically in FIGS. 4A to 4E. In pattern images ImL1 to ImL5 shown in FIGS. 4A to 4E, the pattern images with the denser edge lines indicate that the focus is sharper with respect to the edge lines of a line pattern P1, to simplify the figures.

The description now turns to specific details of the edge reference data for the pattern edges that are used in this case. This edge reference data is data of a pattern that is configured of a plurality of pixels disposed so as to have an intensity gradient. It could be either edge reference data RDe1 having a linear intensity gradient, such as that shown in FIG. 5 by way of example, or edge reference data RDe2 having a non-linear intensity gradient, such as that shown in FIG. 6 by way of example. In addition, the configuration could be such that pattern images in a state in which the focal position conforms are obtained beforehand and the optimal edge reference data is determined from the edges thereof.

The image processor 24 of the pattern measuring apparatus 10 detects the coordinates of the positions of edge points of the patterns by scanning each pattern image with this edge reference data, and also outputs correlations between those edge points and the edge reference data. For details of the edge reference data scanning method and the correlations, refer to Japanese Patent Application No. 2001-294209. The disclosure of this document is herein incorporated by reference.

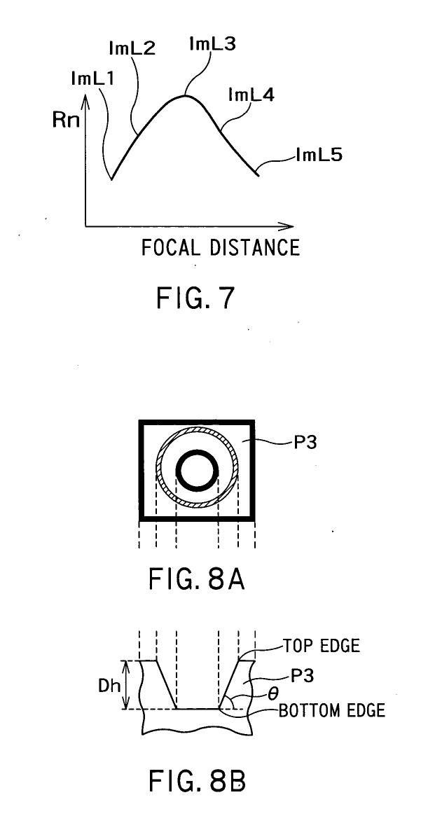

The standardized correlation value calculator 32 then calculates the standardized correlation values Rn. The standardized correlation values Rn are obtained by dividing the total R of correlation values that are output by the image processor 24 by the number of edge points N. The standardized correlation values Rn obtained for the pattern images ImL1 to ImL5 of FIGS. 4A to 4E are shown graphically in FIG. 7. In the graph of FIG. 7, focal distance is plotted along the X-axis and standardized correlation value Rn is plotted along the Y-axis. It can be seen from the example of FIG. 7 that the focal distance at which the pattern image ImL3 of FIG. 4C is captured gives the maximum standardized correlation value Rn, and from that it is clear that the focal distance for the pattern image ImL3 has the best conformation with the edges of the line pattern P1, or is the closest match to that state. The in-focus state determinator 34 determines the in-focus state of each pattern image from the standardized correlation value Rn for each edge line. Receiving these determination results, the pattern image selector 36 selects the pattern image that is at least closest to the state of conforming to the focal point, which is the pattern image ImL3 in this embodiment. Finally, the measurer 38 measures the dimensions such as the pattern width of the line pattern P1 from the thus-selected pattern image ImL3. In this case, the coordinates of the pattern edge points have already been requested by the image processor 24, so that the dimensions such as line width of the line pattern P1 can be measured within a short time and to a high degree of accuracy, if a method such as that disclosed in Japanese Patent Application Laid-Open No. 2002-288677 is used therefor.

Note that in the above-described embodiment, the standardized correlation values Rn are calculated and the determination of in-focus state is done after a plurality of pattern images obtained at different focal distances have been input, but this method is not limited thereto. It is therefore equally possible to determine a range of focal positions for the image patterns beforehand by an initial value and a step width, obtain one pattern image and calculate the standardized correlation value Rn thereof, then proceed only if the thus-obtained standardized correlation value Rn is below a predetermined threshold value. The process of varying the focal distance by just the next step width, calculating the standardized correlation value Rn, then determining the in-focus state is repeated until the result exceeds the predetermined threshold value. The step width in this case can be set to any width, provided it is less than the focal depth of the electronic optical system 84 of the electron beam apparatus 70. In addition, the scanning of each pattern image with the edge reference data need not necessarily be done over the entire range of each pattern image and the range over which the edge positions vary in accordance with changes in the focal distance is also not limited. This means that it is sufficient to scan only within a predetermined range from the edge position of the previously obtained pattern image, which makes it possible to further shorten the inspection time.

(3) Second Embodiment of Pattern Measuring Method

This embodiment takes the measurement of the diameter of the bottom of a concavity of a hole pattern, as shown in FIGS. 8A and 8B, by way of example. In a hole pattern P3 shown in FIGS. 8A and 8B, the depth Dh of that hole is greater than the focal depth of the electronic optical system of the electron beam apparatus. In such a case, it is not possible to capture both the top edge and the bottom edge of the hole pattern P3 simultaneously, with a single focal distance.

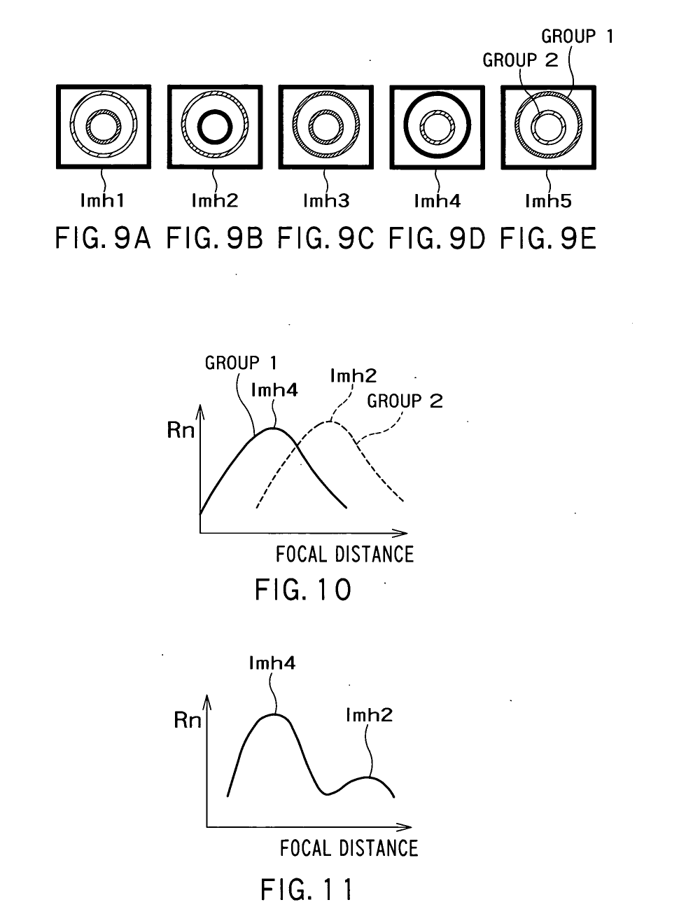

In a similar fashion to the above described first embodiment, a series of pattern images are captured while varying the excitation current to the objective lens (not shown in the figure) of the electronic optical system 84 of the electron beam apparatus 70, to provide pattern images such as those shown in FIGS. 9A to 9E, by way of example.

In the prior art, attempts to focus on such a hole pattern from pattern images Imh1 to Imh5 would select an intermediate state (such as that of the pattern image Imh3 in FIG. 9C) between a state in which the top edge of the hole pattern P3 is in focus, such as the pattern image Imh4 of FIG. 9D, and a state in which the bottom edge of the hole pattern P3 is in focus, such as the pattern image Imh2 of FIG. 9B. This makes it impossible to measure the dimension accurately.

With this embodiment of the present invention, first of all the image processor 24 of the pattern measuring apparatus 10 groups the pattern images Imh1 to Imh5 on the basis of edge points detected therein and the positional coordinates thereof. In this case, all of the edge points are classified into two groups: those belonging to the top edge and those belonging to the bottom edge. The standardized correlation value calculator 32 then calculates the standardized correlation value Rn for each of these groups of edge points (edge lines), and the in-focus state determinator 34 determines the in-focus state of each pattern image from the thus-calculated standardized correlation values Rn, for each group.

A graph of the relationship between the standardized correlation value Rn and focal distance in the pattern images, plotted for each group, is shown in FIG. 10. In the same way as in FIG. 7, focal distance is plotted along the X-axis of FIG. 10 and standardized correlation value Rn is plotted along the Y-axis thereof. It is clear from FIG. 10 that the in-focus state of the pattern images Imh4 and Imh2 appear as peaks in this graph. In other words, it can be seen from the peak of the graph for the edge point group 1 that the focus of the pattern image Imh4 conforms to the top edge of the hole pattern P3 and from the peak of the graph for the edge point group 2 that the focus of the pattern image Imh2 conforms to the bottom edge of the hole pattern P3. Therefore, if the objective is to measure the dimension of the top edge of the hole pattern P3, it could be measured from the edge line of the edge point group 1 of the image pattern Imh4, and if the objective is to measure the dimension of the bottom edge of the hole pattern P3, it could be measured from the edge line of the edge point group 2 of the image pattern Imh2. The pattern image selector 36 of the voltage controller 100 selects the pattern image in accordance with the measurement objective.

In the above description, the edge points are grouped together, but it would be equally possible to not group them and obtain the standardized correlation value Rn for all the edge points in each pattern image. In such a case, the relationship between the standardized correlation value Rn and the focal distance would be as shown in FIG. 11, making it possible to select either pattern image Imh4 or Imh2 for the top or bottom edge, from the peaks of this graph.

(4) Third Embodiment of Pattern Measuring Method

In the above-described second embodiment, measurements are done separately for each of the pattern images Imh4 and Imh2, in accordance with the two peaks of the graph of FIG. 10. With this third embodiment, the measurements are done for an image that is obtained by combining these two images.

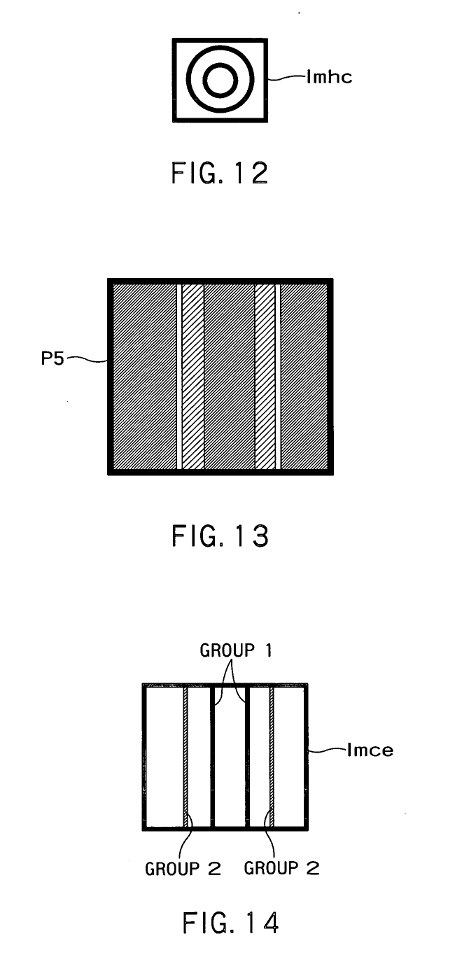

In general, varying the focal distance also moves the position of the image, because of the effects of aberration and the like in the optical system of the image capturing device (the imaging device). For that reason, it is necessary to first combine the pattern images, and then perform the alignment among the composite images. Since the pattern measuring apparatus 10 of FIG. 1 enables the detection of the edge points of the pattern to be measured before the standardized correlation value Rn is calculated, the coordinate information of these edge points can be used for alignment among the related pattern images. Various different methods relating to image combining have already been proposed and any of those combination methods could be used in this embodiment. With the pattern measuring apparatus 10 of FIG. 1, for example, the image combination is done by the image processor 24. A composite image Imhc formed from the pattern images Imh2 and Imh4 of FIGS. 9B and 9D is shown in FIG. 12.

Since the thus-configured embodiment performs the measurement of pattern dimensions or the like with respect to an image that has been obtained by combining other images, it makes it possible to measure features such as the diameter of the bottom of a hole pattern, by way of example. In this case, it also makes it possible to calculate the depth Dh of the hole (see FIG. 8B) if other details such as the angle θ (see FIG. 8B) of the side wall of the hole pattern P3 are known. Conversely, if the depth Dh is already known, it is possible to calculate the angle e of the side wall of the hole pattern P3.

(5) Fourth Embodiment of Pattern Measuring Method

This embodiment provides a method of measuring the hole pattern P3 of FIGS. 8A and 8B, which is different from those of the above-described second and third embodiments.

In the previously-described third embodiment, the pattern dimensions are obtained by measuring a pattern image Imhc that is a composite of the pattern images Imh2 and Imh4, by way of example. However, it could be sufficient to do pattern measurement alone, without being necessary to observe the pattern itself, depending on the objective of the pattern measurement, in which case it is not necessary to combine images. Since the coordinates of the edge points have already been detected by the image processor 24 of the pattern measuring apparatus 10 from the pattern images Imh2 and Imh4 in such a case, coordinate information is used for the relevant pattern images, then the pattern measurement can be done by superposing into the single coordinate system only the edge points that have relatively strongest correlation values, such as correlation values of at least 80% of the maximum strength, of the edge points detected on the pattern images. During this time, it is also possible to measure the dimensions of different edge lines, provided track is kept of which edge point belongs to which pattern image.

(6) Sixth Embodiment of Pattern Measuring Method

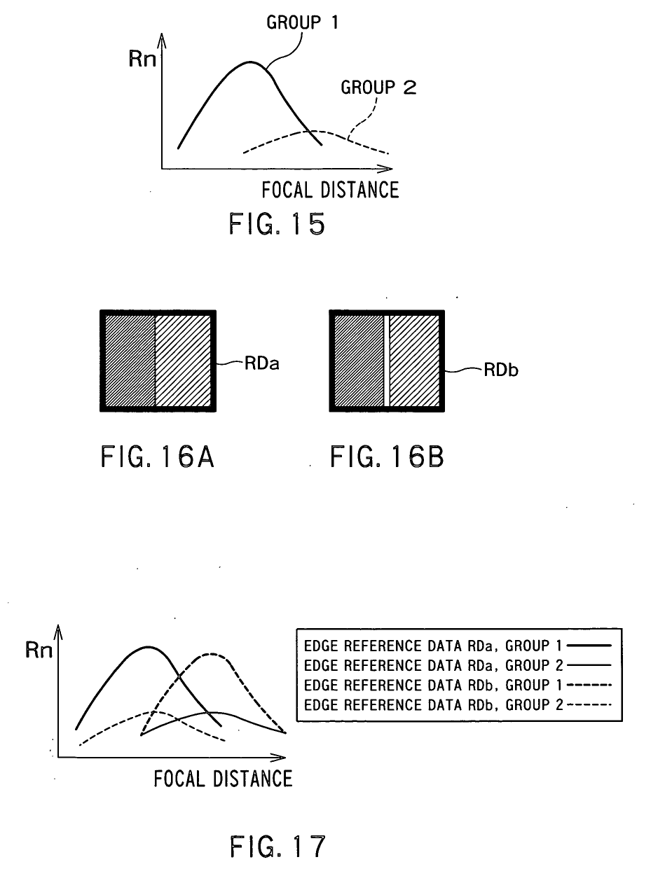

This embodiment is described with reference to a case in which a plurality of patterns having different edges coexist, as shown in a pattern P5 of FIG. 13, by way of example. Such patterns are observed when an upper-layer pattern is formed on top of a lower-layer pattern during the semiconductor manufacturing process. An example of a pattern image Imce captured of the pattern P5 of FIG. 13 is shown in FIG. 14. If a single set of edge reference data such as that of the first embodiment is used with a pattern such as this, in which a plurality of patterns coexist, the graph of the relationship between the standardized correlation value Rn and the focal distance would be as shown in FIG. 15, and the detection sensitivity of the edge having varying-intensity patterns with differing edge reference data will drop dramatically.

In this case, a plurality of sets of edge reference data applicable to each pattern edge is defined beforehand. With this embodiment, two sets of edge reference data RDa and RDb are defined, as shown in FIGS. 16A and 16B.

A graph of the relationship between the standardized correlation value Rn and focal distance, obtained by using the edge reference data RDa and RDb of FIGS. 16A and 16B to scan the pattern image of FIG. 14, is shown in FIG. 17. As is clear from FIG. 17, the edge reference data RDa gives a result that is similar to that of FIG. 15, but the edge reference data RDb forms a maximum value at a high correlation value, making it possible to detect the edge points with a good sensitivity from the pattern image at which a suitable focal distance was obtained for the edge lines for group 2.

(7) Manufacturing Method of Semiconductor Device

Since the use of one of the embodiments of the pattern measuring method described above in the manufacture of a semiconductor device makes it possible to inspect patterns formed on substrates with higher accuracy and more rapidity, it is possible to manufacture semiconductor devices with a high throughput and a good yield.

What is claimed is:

1. A pattern measuring apparatus comprising:
a storage device which stores a plurality of pattern images of a pattern to be measured and edge reference data which is used as reference to detect the edge of the pattern within the pattern images and is configured of a plurality of pixels that are disposed so as to have an intensity gradient, the pattern images being obtained by an external imaging device at different focal distances;
a calculator which scans the pattern image with said edge reference data, detects edge points of the pattern, and also calculates a characteristic quantity that expresses a correlation between said edge reference data and the detected edge points of the pattern;
a determinator which determines an in-focus state that expresses the degree to which the focal position at which each pattern image is obtained conforms to a desired pattern edge, based on the calculated characteristic quantity;
an image selector which selects the pattern image that conforms to measurement of the pattern from a plurality of the pattern images, in accordance with the determination result of said in-focus state determinator; and
a measurer which processes the selected pattern image to measure the pattern.

2. The pattern measuring apparatus according to claim 1,
wherein said external imaging device includes an optical system which is capable of adjusting focal position thereof within a range defined by an integer multiple of a predetermined step width from a predetermined initial value; and
the plurality of the pattern images are pattern images that have been obtained by imaging at each of focal positions calculated by adding integral multiples of the step width to said initial value.

3. The pattern measuring apparatus according to claim 1,
wherein said image selector selects a plurality of pattern images in accordance with the determination results of said in-focus state determinator;
said pattern measuring apparatus further comprises an image processor which performs alignment processing among said selected plurality of pattern images and superimposes in a single coordinate system the edge points of the pattern within the pattern images; and
said measurer measures the pattern on the basis of position coordinates of pattern edge points that have been superposed in said single coordinate system.

4. The pattern measuring apparatus according to claim 1,
wherein said image selector selects a plurality of pattern images in accordance with the determination results of said in-focus state determinator;
said pattern measuring apparatus further comprises an image processor which performs alignment processing between said selected plurality of pattern images and performs image processing to combine the selected pattern images; and
said measurer measures the pattern on the basis of the combined pattern images.

5. The pattern measuring apparatus according to claim 1,
wherein only edge points of the pattern which have been detected from previously processed pattern images and which are within a predetermined range are scanned with said edge reference data.

6. The pattern measuring apparatus according to claim 1,
wherein the pattern has a plurality of edge lines;
said calculator classifies said edge points that have been detected into edge point groups for each of said edge lines, and calculates a characteristic quantity for each of said edge point groups that have been classified; and
said determinator determines the in-focus state of the pattern image for each of said edge point groups that have been classified.

7. A pattern measuring apparatus which is connectable to an external imaging device and which inspects a pattern to be measured on the basis of a pattern image supplied from the external imaging device, the external imaging device capturing an image of the pattern to be measured with an optical system, a focal position of the optical system being adjustable with respect to the pattern by an integer multiple of a predetermined step width from a predetermined initial value, said pattern measuring apparatus comprising:
a storage device which stores edge reference data which is used as reference to detect the edge of the pattern within pattern images and which is configured of a plurality of pixels that are disposed so as to have an intensity gradient;
a characteristic quantity calculator which scans each pattern image with said edge reference data, detects edge points of the pattern to be measured, and also calculates a characteristic quantity that expresses a correlation between the detected pattern and said edge reference data;
a determinator which determines an in-focus state that expresses the degree to which the focal position at which each pattern image is obtained conforms to a desired pattern edge, based on said characteristic quantity that has been calculated;
a measurer which operates to process the pattern image to measure the pattern if said determinator has determined that the focal position at the time of capture of the pattern image conforms to said desired pattern edge; and
a focal-position controller which generates and outputs control signals to change the focal position of the optical system of the external imaging device if said determinator has determined that the focal position at the time of capture of the pattern image does not conform to said desired pattern edge.

8. The pattern measurement apparatus according to claim 7,
wherein only a predetermined range of edge points of the pattern which have been detected from previously processed pattern images are scanned with said edge reference data.

9. The pattern measurement apparatus according to claim 7,
wherein the pattern to be measured has a plurality of edge lines;
said characteristic quantity calculator classifies said edge points that have been detected into edge point groups for each edge line to calculate said characteristic quantity for each of said edge point groups that have been classified; and
said determinator determines the in-focus state of the pattern images for each of said edge point groups that have been classified.

10. The pattern measuring apparatus according to claim 7,
wherein said characteristic quantity is calculated by using a plurality of sets of said edge reference data.

11. A method of measuring a pattern to be measured from a plurality of pattern images obtained by capturing the pattern by an imaging device at different focal positions, said pattern measuring method comprising:
detecting edge points of a pattern to be measured by scanning the pattern with edge reference data which is used as reference to detect the edges of the pattern within pattern images and which is configured of a plurality of pixels that are disposed so as to have an intensity gradient, and also calculating a characteristic quantity which expresses a correlation between said edge reference data and the pattern, the edge points of which have been detected;
determining an in-focus state that expresses the degree to which the focal position at which each obtained pattern image is obtained conforms to a desired pattern edge, based on said characteristic quantity that has been calculated;
selecting the pattern image which conforms to measurement of the pattern from a plurality of the pattern images, in accordance with the result of determining said in-focus state; and
processing the selected pattern image to measure the pattern.

12. The pattern measurement method according to claim 12,
wherein the imaging device includes an optical system which is capable of adjusting focal position thereof within a range defined by an integer multiple of a predetermined step width from a predetermined initial value; and
the plurality of the pattern images are pattern images that have been obtained by imaging at each of focal positions calculated by adding integral multiples of the step width to said initial value.

13. The pattern measuring method according to claim 11,
wherein a plurality of pattern images are selected in accordance with the result of determining said in-focus state; and
said pattern measuring method further comprises aligning among the selected pattern images, said pattern edge points being superimposed in a single coordinate system within the pattern images, and the pattern being measured on the basis of the position coordinates of the superimposed pattern edge points.

14. The pattern measuring method according to claim 11,
wherein a plurality of pattern images are selected in accordance with the result of determining said in-focus state; and
said pattern measuring method further comprises aligning the selected pattern images and combining the pattern images, the pattern being measured based on the combined pattern images.

15. The pattern measuring method according to claim 11, further comprising:
scanning with said edge reference data only a predetermined range of edge points of the pattern which have been detected from previously processed pattern images.

16. The pattern measuring method according to claim 11,
wherein the pattern to be measured has a plurality of edge lines;
said pattern measuring method further comprises classifying said edge points that have been detected into edge point groups for each edge line;
wherein said characteristic quantity is calculated for each of said edge point groups that have been classified; and
the in-focus state of the pattern images is determined for each of said edge point groups that have been classified.

17. The pattern measuring method according to claim 11,
wherein said characteristic quantity is calculated by using a plurality of sets of said edge reference data.

18. A method of measuring a pattern based on an image of a pattern to be measured which is obtained by an imaging device which captures the pattern to be measured and includes an optical system with a focal position thereof being adjustable with respect to the pattern by an integer multiples of a predetermined step width from an initial value, said method comprising:
detecting edge points of a pattern to be measured by scanning an image of the pattern with edge reference data which is used as reference to detect the edge points of the pattern and which is configured of a plurality of pixels that are disposed so as to have an intensity gradient, and calculating a characteristic quantity which expresses a correlation between said edge reference data and the pattern, the edge of which has been detected;
determining an in-focus state that expresses the degree to which the focal position at which each pattern image is obtained conforms to a desired pattern edge, based on said characteristic quantity that has been calculated;
processing the image of the pattern to measure the pattern if it has been determined that the focal position at the time of capture of the pattern image conforms to said desired pattern edge; and
obtaining a new image of the pattern at different focal positions until it is determined that it conforms to said desired pattern edge by varying the focal position of the optical system if it has been determined that the focal position at the time of capture of the pattern image does not conform to said desired pattern edge.

19. A method of manufacturing a semiconductor device comprising a method of measuring a pattern to be measured from a plurality of pattern images captured and obtained at different focal positions by a pattern imaging device, said method of measuring the pattern including:
detecting edge points of a pattern to be measured by scanning the pattern with edge reference data which is used as reference to detect the edges of the pattern within pattern images and which is configured of a plurality of pixels that are disposed so as to have an intensity gradient, and also calculating a characteristic quantity which expresses a correlation between said edge reference data and the pattern, the edge points of which have been detected;
determining an in-focus state that expresses the degree to which the focal position at which each obtained pattern image is obtained conforms to a desired pattern edge, based on said characteristic quantity that has been calculated;
selecting the pattern image which conforms to measurement of the pattern from a plurality of the pattern images, in accordance with the result of determining said in-focus state; and
processing the selected pattern image to measure the pattern.

20. A method of manufacturing a semiconductor device comprising a method of measuring a pattern based on an image of a pattern to be measured which is obtained by an imaging device which captures the pattern to be measured and includes an optical system with a focal position thereof being adjustable with respect to the pattern by an integer multiples of a predetermined step width from an initial value, said method of measuring the pattern including:
detecting edge points of a pattern to be measured by scanning an image of the pattern with edge reference data which is used as reference to detect the edge points of the pattern and which is configured of a plurality of pixels that are disposed so as to have an intensity gradient, and calculating a characteristic quantity which expresses a correlation between said edge reference data and the pattern, the edge of which has been detected;
determining an in-focus state that expresses the degree to which the focal position at which each pattern image is obtained conforms to a desired pattern edge, based on said characteristic quantity that has been calculated;
processing the image of the pattern to measure the pattern if it has been determined that the focal position at the time of capture of the pattern image conforms to said desired pattern edge; and
obtaining a new image of the pattern at different focal positions until it is determined that it conforms to said desired pattern edge by varying the focal position of the optical system if it has been determined that the focal position at the time of capture of the pattern image does not conform to said desired pattern edge.
